(19) United States
(12) Patent Application Publication
(10) Pub. No.: US 2011/0240072 A1
(43) Pub. Date: Oct. 6, 2011

(54) PROTECTIVE COVER FOR A MOVABLE CARRIAGE

(76) Inventor: Gina Barac-Bauer, (US)

(21) Appl. No.: 12/750,963

(22) Filed: Mar. 31, 2010

(51) Int. Cl. A45B 3/00; B23P 11/00

(52) U.S. Cl. 135/16; 29/525.02

(57) ABSTRACT

In view of the foregoing, an embodiment herein provides a protective cover for manually operated movable carriages. Specifically, the protective cover of the present invention includes a double layered canopy portion and a shaft portion, wherein the shaft portion further includes an attachment device that can be securely clamped onto the body of such movable carriages. A dual clamp mechanism is provided with the attachment device to help an operator adjust the orientation of the protective cover according to his requirement and also to allow a 360° rotation to a closed protective cover thus achieving an easy storage solution. Further, the protective cover is structured and designed to withstand extreme weather conditions without getting toppled over.

### BACKGROUND

1. Technical Field

The embodiments herein generally relate to an all-purpose protective cover configured to be used with a movable carriage. Specifically, the embodiments described herein relate to an umbrella cover configured to protect operator of a carriage from weather extremities such that the cover is conveniently mountable on the carriage.

2. Description of the Related Art

Manually operated movable carriages, specifically, wheel chairs and baby strollers, have elaborate arrangements for the safety and well being of its occupants but seldom focus on the operator who handles such carriages. An operator of such a carriage has to manage the movement of the carriage which generally involves both his hands, thus making it further difficult for him to use a protective cover, like an umbrella, with one hand and to maneuver the carriage with the other.

U.S. Pat. No. 4,919,379 discloses a universal clamping fixture for attaching a wide variety of umbrellas, sunscreens etc. to a baby carriage. The clamps provided therein are rigid and provide a very restrictive movement to the umbrella forcing the operator to be satisfied with an orientation of the umbrella that he has clamped and is practically helpless if, say, the wind or rain, changes direction.

U.S. Pat. No. 6,244,557 discloses an umbrella mounting device for a stroller. The patent, however, describes such placement of said mounting device (and hence the umbrella) that it blocks the forward view of the operator. Also, the patent fails to provide any arrangement for keeping back the umbrella when not in use.

US 20090205692 relates to shades that could be attached to walkers and other mobility aids. The shades of the '692 published application can be rotated from a functionally horizontal orientation to a functionally vertical orientation around a connector joint placed on the shaft bearing the shade. The shaft, in turn, is attached to the walker through a pair of frictional collars. Such an arrangement is restrictive of a full rotation of the shade bearing shaft and even in a closed shade state, the shaft is held in an upright position, thus creating an unwarranted obstacle in the path of the operator.

U.S. Pat. No. 7,493,708 discloses an umbrella that could be attached to a stroller. The umbrella is fairly large to cover the operator as well as the entire carriage and requires an additional counterweight to balance the weight of the umbrella. Further, straps are provided at the rear end of the umbrella which is fastened to the legs of the operator. Such an arrangement is not only cumbersome for the operator but also creates a nuisance in the public.

There therefore exists a need in the art to provide for a protective cover that not only provides an operator desired shield from weather extremities but is also attached to the carriage in a manner that it allows an operator the flexibility to not only rotate and configure the cover according to his need but also adjust the height of the cover so as to withstand different weather conditions and take operator's height into consideration. Further, a protective cover of such nature must also be designed in a manner to not let wind or heavy rain topple it to an inverted position. Finally, the protective cover must take minimal space, should be less cumbersome, and be convenient to use and store.

### SUMMARY

In view of the foregoing, an embodiment herein provides a protective cover for manually operated movable carriages. Specifically, the protective cover of the present invention includes a double layered canopy portion and a shaft portion, wherein the shaft portion further includes an attachment device that can be securely clamped onto the body of such movable carriages. A dual clamp mechanism is provided with the attachment device to help an operator adjust the orientation of the protective cover according to his requirement and also to allow a 360° rotation to a closed protective cover thus achieving an easy storage solution. Further, the protective cover is structured and designed to withstand extreme weather conditions without getting toppled over.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar items.

FIG. 1 illustrates side view of a baby carriage with a protective cover in open position according to an embodiment herein;

FIG. 2 illustrates front view of a protective cover according to an embodiment herein;

FIG. 3 illustrates side view of an attachment device according to an embodiment herein;

FIG. 4 illustrates different orientations of a protective cover achieved through a clamp mechanism according to an embodiment herein;

FIG. 5 illustrates side view of a baby carriage with a protective cover in closed position according to an embodiment herein;

FIG. 6 illustrates a mechanism to achieve desired height of a protective cover according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

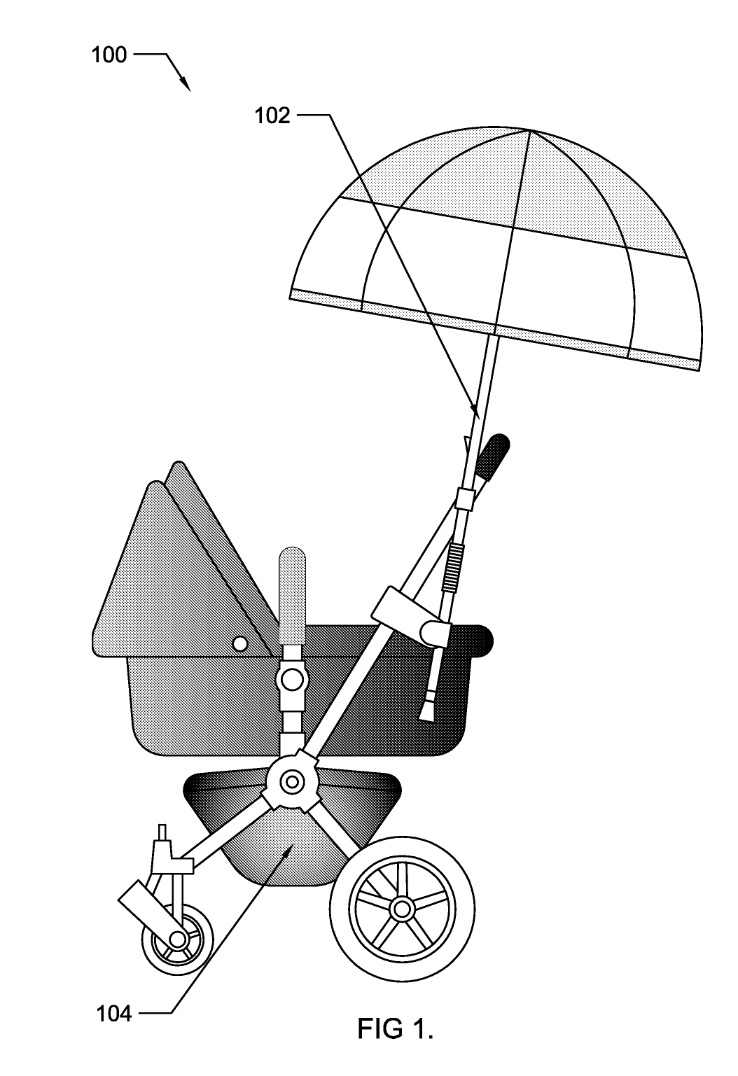

FIG. 1 illustrates a device 100 depicting a protective cover 102 attached to a baby carriage 104, also referred to as stroller hereinafter, according to an embodiment. The protective cover 102 can be configured to protect the caregiver of the stroller 104 from rain, sun, and wind. In an embodiment, the protective cover 102 can be attached to the baby carriage 104 through an attachment means, as would be described in detail with reference to subsequent figures.

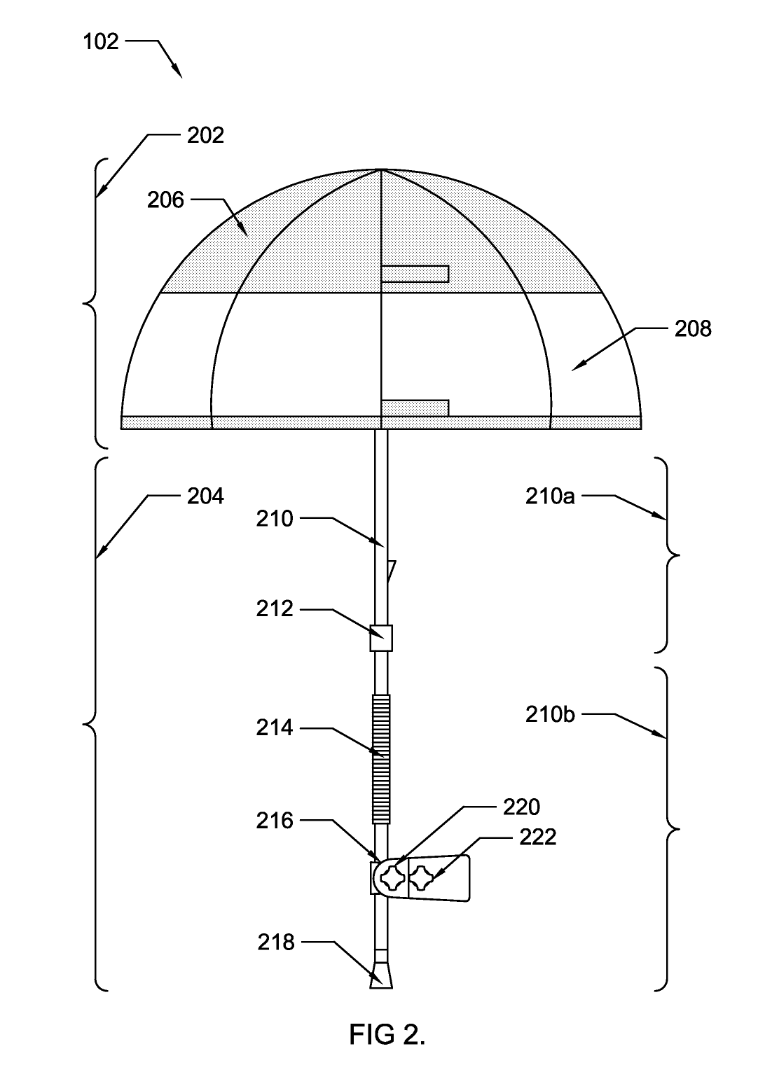

FIG. 2 illustrates front view of a protective cover 102. In an embodiment, the protective cover 102 can be an umbrella or an umbrella like device. In another embodiment, the protective cover 102 includes a canopy portion 202 and a shaft portion 204. The canopy portion 202 of the protective cover 102 can further include an upper portion 206 and a lower portion 208. In an embodiment, the upper portion 206 of the canopy 202 can be made of an SUV and a permeable textile material and the lower portion 208 of the canopy 202 can be made of a clear permeable textile. The upper portion 206, through an SUV and permeable textile based material, provides a durable and rigid support to the protective cover 102 and is made of suitable, weather-proof material to bear conditions like harsh rain drops, frozen precipitation etc. The lower portion 208 of the canopy 202, on the other hand, is made of a transparent material to allow the operator or caregiver of the stroller 104 clear visibility. In an embodiment, the upper portion 206 and the lower portion 208 can be placed over each other so as to create a vented hood design for the canopy 202. Such design ensures a secure exit of incoming wind, thereby preventing the protective cover 102 from inverting against the force of wind.

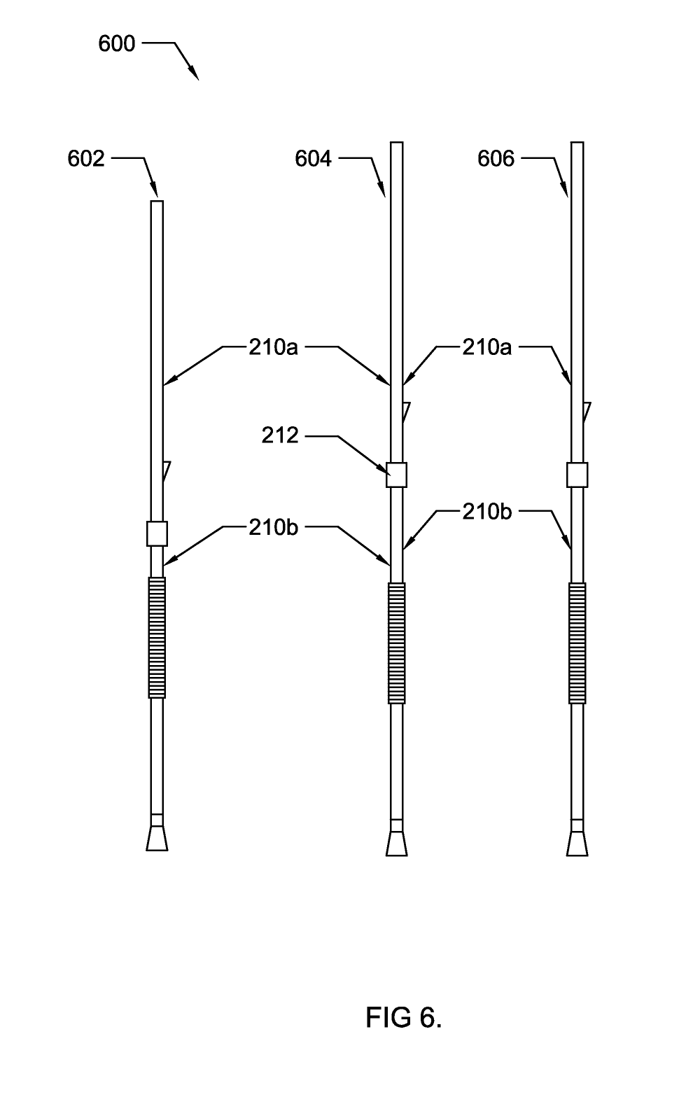

The shaft portion 204 of the protective cover 102, in an embodiment, comprises a central shaft 210, a telescoping means 212, a flexible metal tubing 214, an attachment device 216 and a flared end piece 218. In an embodiment, the central shaft 210 can comprise of two or more central shaft components, with one shaft component being slidably movable within the recess of the other component. The different shaft components of the central shaft 210 can be joined at the telescoping means 212. Referring to FIG. 2, shaft component 210b of central shaft 210 is slidable against the recess of slide components 210a as is explained in detail in FIG. 6. The central shaft 210 is preferably made of aluminum and metal so as to provide a lightweight yet stiff protective cover which is durable and weather-proof.

In another embodiment, the telescoping means 212 can be provided at a point where two shaft components of the central shaft 210 meet. The telescoping means 212 is a rotating sleeve that allows for adjustment of umbrella height. Twisting the telescoping means 212 in an anti-clockwise manner loosens the connection between the two shaft components allowing for the two shaft components to slide freely. An operator can then adjust the length of the central shaft 210 as per his/her convenience. Once the desired length is achieved, the telescoping means 212 can be twisted in a clock-wise manner to hold the shaft components of the central shaft 210 in their current position. The length adjusting feature is particularly useful for users of different heights who want the protective cover to be matching to their heights. This feature can also be useful under circumstances where one needs to adjust the height of the protective cover 102 depending upon the intensity of wind or rain.

In another embodiment, the flexible metal tubing 214 can be provided at a shaft component of the central shaft 210 to allow for small adjustments in the direction of the protective cover 102. Functionally, moving the protective cover 102 bends the flexible metal tubing 214. The metal tubing 214 retains its shape until it is bent into another position. Thus, the flexible metal tubing 214 provides an axis of maneuvering the direction of the protective cover 102.

In yet another embodiment, the attachment device 216 provided on the shaft portion 204 further comprises of an inner clamp 220 and an outer clamp 222. The attachment device 216 is a means to attach the protective cover 102 to the body of the carriage 104, also referred to as stroller and/or baby carriage. A dual clamp mechanism, as is described below with reference to subsequent figures, can be configured to the attachment device 216 to provide separate clamps to attach, respectively, to the central shaft 210 of the protective cover 102 and the carriage body 104. The positioning of the two clamps in close vicinity and on the same device ensures that this arrangement is clutter free and occupies a minimum possible space. The dual clamp mechanism also provides an additional benefit of swirling a closed protective cover 102 around the inner clamp axis for easy storage. The attachment device 216 can be designed to be comfortably attached to any type of carriage.

In yet another embodiment, the flare end 218 towards the end of the central shaft 210 is designed so as to provide a smooth edge to an operator using the protective cover 102. The flare end 218 can, preferably, be of a tapering nature and be made of smooth polymeric material.

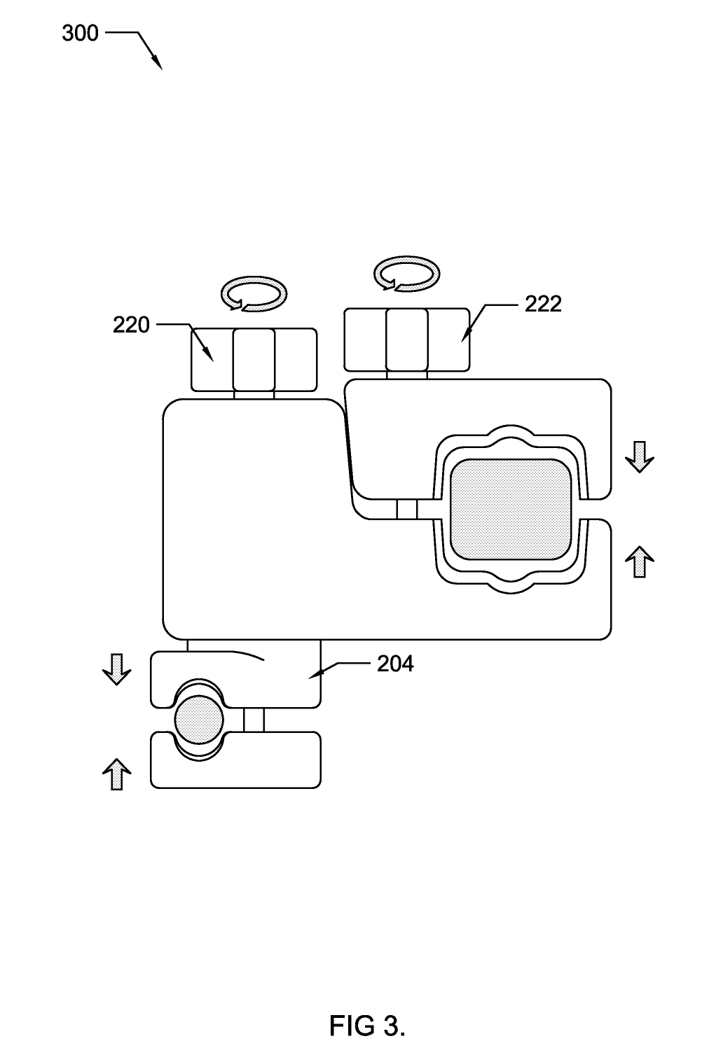

FIG. 3 illustrates side view 300 of the attachment device 216 according to an embodiment. The inner clamp 220, also referred to as upper clamp 220 hereinafter, can be configured to attach to the shaft portion 204 of the protective cover 102 and provide a firm grip to the protective cover 102 while the outer clamp 222, also referred to as the lower clamp 222 hereinafter, can be configured to attach to the carriage body 104, thereby providing a firm grip to the carriage 104. This gives the operator of the carriage 104 an advantage to not engage his hands to hold the protective cover 102 and instead use his hands to maneuver the carriage 104. The clamps, 220 and 222, can be rotated around their own axis and their clockwise or anticlockwise twisting can tighten or loosen their respective attachment to central shaft 210 of the carriage body 104. The tightening and loosening of the inner clamp 220 can be particularly helpful in setting a preferred orientation for the protective cover 102. In yet another embodiment, the attachment mechanism can also be used with other carriage 104 and/or strollers.

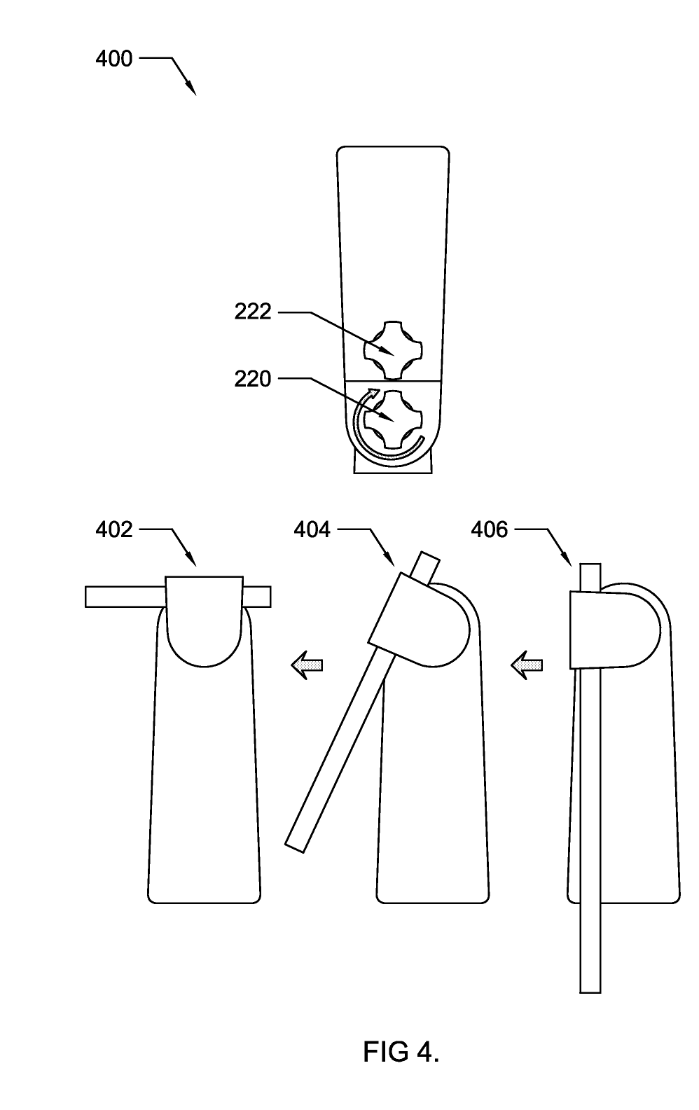

FIG. 4 illustrates different orientations 400 of a protective cover 102 achieved through a clamp mechanism according to an embodiment. Orientations 400 can include different orientations 402, 404, and 406 of the central shaft 210, and hence of the protective cover 102, achieved due to differential rotation of the central shaft 210 brought about by loosening the inner clamp 220. Once the desired orientation is set, the inner clamp 220 can be tightened in its position. The outer clamp 222 can remain attached to the carriage body 104 during the whole exercise. In a preferred embodiment, the clamps are made of heavy duty plastic and aluminum. Orientation 402 demonstrates an open position of the protective cover 102 and the orientation 406 demonstrates the closed position of the protective cover 102.

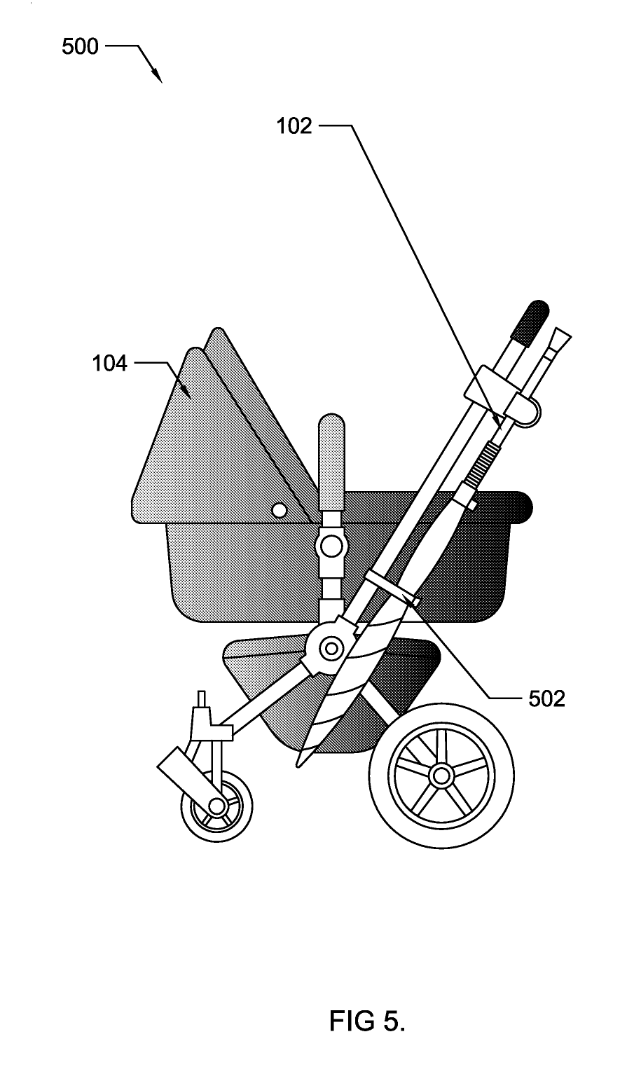

FIG. 5 illustrates a side view 500 of a baby carriage 104 with a protective cover 102 in closed position according to an embodiment. Referring to FIG. 5, the inner clamp 220 enables an operator to place the closed protective cover 102 at a location adjacent to the main body of the carriage 104. The closed protective cover 102, when not in use, can be rotated around the inner clamp 220 and placed sideways to a handle or bar of the carriage 104. The inner clamp 220 enables a 360° rotation of the closed protective cover 102. Further, the handle or bar can be configured to provide a strap 502 to keep the closed protective cover 102 at its position. This offers a simplistic and clutter free arrangement to store the protective cover 102 when not in use. Also, when desired to use, the mechanism offered, as disclosed in the embodiment described above, to open the protective cover is simple and easy-to-follow. The operator, in such cases, can free the strap 502 and rotate the protective cover 102 along the inner clamp 220 axis to an upright position and open the protective cover 102. The direction and height of the protective cover 102 can then be adjusted according to the embodiments described above. The clamping mechanism of the present invention, thus, provides an advantage not only in terms of space and convenience of use to an operator, but, functionally, by allowing an operator to adjust the height and bend of the protective shield as well as providing a complete flexibility of rotating the protective cover by 360 degree, also offer novel solution to the operator.

FIG. 6 illustrates a mechanism 600 to adjust the length of the central shaft 210 using the telescopic means 212 according to an embodiment. At 602, the central shaft 210 is provided with distinct shaft components 210a and 210b joined at the telescopic means 212. The telescopic means 212, as mentioned above, is a sleeve which can be twisted to effect a loosening or tightening the connection between the two shaft components allowing them to slide freely against each other. At 602, the telescopic means 212 is loosened to ease the connection between the shaft components 210a and 210b so as to enable the shaft component 210b to be slidable against the recess of shaft component 210a. At 604, the length of the central shaft 210 is adjusted by allowing just the right length of the shaft component 210b to slide against the recess of shaft component 210a. At 606, once the desired length is achieved, the telescoping means 212 is tightened to hold the shaft components of the central shaft 210 in their current position.

What is claimed is:

1. A protective cover for a movable carriage comprising:
a canopy portion; and
a shaft portion comprising of an attachment device, wherein said attachment device further comprises of a dual clamp mechanism configured to separately engage said shaft portion and said movable carriage.

2. The protective cover of claim 1, wherein said dual clamp mechanism further comprises an inner clamp and an outer clamp, wherein said inner clamp is configured to attach to said shaft portion of said protective cover and said outer clamp is configured to attach to body of said movable carriage.

3. The protective cover of claim 2, wherein said inner clamp provides an arrangement for tightening and loosening said shaft portion of protective cover.

4. The protective cover of claim 2, wherein said attachment device with said inner clamp provides an axis of rotation for said shaft portion.

5. The protective cover of claim 4, wherein said inner clamp allows 360 degree rotation of said shaft portion.

6. The protective cover of claim 2, wherein said inner clamp and said outer clamp is made of heavy duty plastic and aluminum parts.

7. The protective cover of claim 1, wherein said shaft portion further comprises a telescoping means, wherein said telescoping means is configured to adjust length of said shaft portion.

8. The protective cover of claim 1, wherein said shaft portion further comprises flexible metal tubing, wherein said flexible metal tubing is configured to tilt said protective cover.

9. The protective cover of claim 1, wherein said canopy portion comprises of a two-layered hood, wherein said two-layered hood further comprises of a durable and weather-proof upper layer, and a clear and transparent lower layer.

10. The protective cover of claim 9, wherein said two-layered hood provides a vented hood to make said protective cover stable in windy conditions.

11. The protective cover of claim 1, wherein said attachment device can be attached to carriages of varied types.

12. A protective cover for a baby stroller, said protective cover comprising:
a canopy portion comprising of an upper layer and a lower layer;
a shaft portion comprising of an attachment device, wherein said attachment device further comprises of a dual clamp mechanism to separately engage said shaft portion and said baby stroller.

13. The protective cover of claim 12, wherein said upper layer of said canopy portion is made of a durable and weather-proof material and said lower layer of said canopy portion is made of clear and transparent material.

14. The protective cover of claim 12, wherein said canopy portion provides a vented hood to make said protective cover stable in windy conditions.

15. The protective cover of claim 12, wherein said shaft portion further comprises of a telescoping means, wherein said telescoping means is configured to adjust length of said shaft portion.

16. The protective cover of claim 12, wherein the shaft portion further comprises flexible metal tubing, wherein said flexible metal tubing is configured to bend said protective cover.

17. The protective cover of claim 12, wherein said dual clamp mechanism further comprises an inner clamp and an outer clamp, wherein said inner clamp is configured to attach to said shaft portion of said protective cover and said outer clamp is configured to attach to body of said baby stroller.

18. The protective cover of claim 17, wherein said outer clamp provides an arrangement for tightening and loosening body of said baby stroller.

19. A method of attaching a protective cover to a movable carriage, said method comprising,
attaching a shaft portion of said protective cover to an inner clamp provided at an attachment device, wherein said attachment device is attached to said shaft portion,
attaching a body portion of said movable carriage to an outer clamp provided at an attachment device, wherein said attachment device is attached to said shaft portion.

20. The method of claim 19 further comprising attaching a canopy portion to said shaft portion of said protective cover, wherein said canopy portion comprises of a two-layered hood comprising of a durable and weather-proof upper layer and a clear and transparent lower layer.
